(19) United States
(12) Patent Application Publication
(10) Pub. No.: US 2025/0055002 A1
(43) Pub. Date: Feb. 13, 2025

(54) FUEL CELL STACK

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP); Akihiro INUKAI, Okazaki-shi (JP); Kensuke DOI, Obu-shi (JP)

(73) Assignee: TOYOTA BOSHOKU KABUSHIKI KAISHA, Aichi-ken (JP)

(21) Appl. No.: 18/789,811

(22) Filed: Jul. 31, 2024

(30) Foreign Application Priority Data
Aug. 7, 2023 (JP) 2023-128551

(51) Int. Cl. H01M 8/0263; H01M 8/00; H01M 8/04007; H01M 8/04082

(52) U.S. Cl. CPC H01M 8/0263; H01M 8/006; H01M 8/04007; H01M 8/04201

(57) ABSTRACT

A fuel cell stack includes stacked single cells. The single cells each include a power generation portion and a pair of a first separator and a second separator. The first separator includes first passages. The first passages each include first reversal portions and first general portions. The second separator includes second passages. The second passages each include second reversal portions and second general portions. The first reversal portions of the first passages each extend to increase a flow resistance of a cooling medium flowing through a part of a cooling medium flow region that corresponds to the first reversal portion. The second reversal portions of the second passages each extend to increase the flow resistance of the cooling medium flowing through a part of the cooling medium flow region that corresponds to the second reversal portion.

### CROSS-REFERENCE TO RELATED APPLICATIONS

This application is based upon and claims the benefit of priority from prior Japanese Patent Application No. 2023-128551, filed on Aug. 7, 2023, the entire contents of which are incorporated herein by reference.

### BACKGROUND

### 1. Field

The present disclosure relates to a fuel cell stack in which single cells are stacked.

### 2. Description of Related Art

Typical single cells of a fuel cell stack are disclosed in, for example, Japanese Laid-Open Patent Publication No. 2006-147466. Each single cell includes an electrolyte membrane-electrode assembly, an anode-side metal separator, and a cathode-side metal separator. The anode-side metal separator and the cathode-side metal separator sandwich the electrolyte membrane-electrode assembly. The single cell has a rectangular plate shape as a whole. An oxidant gas inlet hole for supplying an oxidant gas and a fuel gas outlet hole for discharging a fuel gas are formed at one edge of the single cell in the long-side direction.

A fuel gas inlet hole for supplying the fuel gas and an oxidant gas outlet hole for discharging the oxidant gas are formed at the other edge of the single cell in the long-side direction. A cooling medium inlet hole for supplying a cooling medium is formed at one edge of the single cell in the short-side direction. A cooling medium outlet hole for discharging the cooling medium is formed at the other edge of the single cell in the short-side direction.

On the surface of the anode-side metal separator facing the electrolyte membrane-electrode assembly, a fuel gas passage is formed by recesses and projections in a complementary relationship. The fuel gas passage is connected to the fuel gas inlet hole and the fuel gas outlet hole. The fuel gas passage includes wave-shaped passage grooves and embossed portions. The fuel gas passage forms a serpentine passage as a whole with two turning partition members that are spaced apart from each other in the short-side direction and arranged in a zigzag manner in the long-side direction. The fuel gas passage includes the two turning portions and the embossed portions arranged for the two turning portions.

On the surface of the cathode-side metal separator facing the electrolyte membrane-electrode assembly, an oxidant gas passage is formed by recesses and projections in a complementary relationship. The oxidant gas passage is connected to the oxidant gas inlet hole and the oxidant gas outlet hole. The oxidant gas passage includes wave-shaped passage grooves and embossed portions. The oxidant gas passage forms a serpentine passage as a whole with two turning partition members that are spaced apart from each other in the short-side direction and arranged in a zigzag manner in the long-side direction. The oxidant gas passage includes the two turning portions and the embossed portions arranged for the two turning portions.

A cooling medium passage connected to the cooling medium inlet hole and the cooling medium outlet hole extends in the short-side direction between the anode-side metal separator of one of two single cells, adjacent to each other in the stacking direction, and the cathode-side metal separator of the other one of the two single cells. That is, the cooling medium passage is formed between the fuel gas passage and the oxidant gas passage. The cooling medium flows through the cooling medium passage from the cooling medium inlet hole toward the cooling medium outlet hole.

In the above-described fuel cell stack, the cooling medium flowing through the cooling medium passage receives a higher resistance in a part of the cooling medium passage that corresponds to the wave-shaped passage grooves of gas passage than in a part of the cooling medium passage that corresponds to the embossed portions of gas passage. Thus, the cooling medium passage has a part where the cooling medium flows easily and a part where the cooling medium flows less easily. This results in significant variation in the cooling effect of the cooling medium in the single cell.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fuel cell stack includes stacked single cells. The single cells each have a plate shape and include a power generation portion and a pair of a first separator and a second separator that sandwiches the power generation portion. The single cells each include a fuel gas supply hole through which a fuel gas is supplied, a fuel gas discharge hole through which the fuel gas is discharged, an oxidant gas supply hole through which an oxidant gas is supplied, and an oxidant gas discharge hole through which the oxidant gas is discharged. The fuel gas supply hole is formed at a first end that is one of two ends of the single cell in a first direction. The fuel gas discharge hole is formed at a second end that is the other one of the two ends of the single cell in the first direction. The oxidant gas supply hole is formed at one of the first end and the second end of the single cell in the first direction. The oxidant gas discharge hole is formed at the other one of the first end and the second end of the single cell in the first direction. The single cells each further include a cooling medium supply hole through which a cooling medium is supplied, and a cooling medium discharge hole through which the cooling medium is discharged. The cooling medium supply hole is formed at a first end that is one of two ends of the single cell in a second direction orthogonal to the first direction. The cooling medium discharge hole is formed at a second end that is the other one of the two ends of the single cell in the second direction. The first separator includes recesses and projections in a complementary relationship. The recesses and projections form first passages for supplying the oxidant gas to one of surfaces of the power generation portion from the oxidant gas supply hole to the oxidant gas discharge hole. The first passages serve as meandering passages in which a flow direction of the oxidant gas is reversed multiple times. The first passages each include first reversal portions for reversing a flow of the oxidant gas and first general portions different from the first reversal portions. The second separator includes recesses and projections in a complementary relationship. The recesses and projections form second passages for supplying the fuel gas to the other one of the surfaces of the power generation portion from the fuel gas supply hole to the fuel gas discharge hole. The second passages serve as meandering passages in which a flow direction of the fuel gas is reversed multiple times. The second passages each include second reversal portions for reversing a flow of the fuel gas and second general portions different from the second reversal portions. A cooling medium flow region through which the cooling medium flows from the cooling medium supply hole toward the cooling medium discharge hole is formed between the first separator of one of two single cells, adjacent to each other in a stacking direction, and the second separator of the other one of the two single cells. At least part of at least either the first general portions of the first passages or the second general portions of the second passages is a wave-shaped portion extending in a wave-shaped manner. The first reversal portions of the first passages each extend to increase a flow resistance of the cooling medium flowing through a part of the cooling medium flow region that corresponds to the first reversal portion. The second reversal portions of the second passages each extend to increase the flow resistance of the cooling medium flowing through a part of the cooling medium flow region that corresponds to the second reversal portion.

Other features and aspects will be apparent from the following detailed description, the drawings, and the claims.

### BRIEF DESCRIPTION OF THE DRAWINGS

FIG. 1 is a schematic cross-sectional view of a fuel cell according to an embodiment.

FIG. 2 is an exploded perspective view showing a single cell.

FIG. 3 is a plan view of a fuel cell stack.

FIG. 4 is an enlarged partial view of FIG. 3.

FIG. 5 is a cross-sectional view of recesses and projections forming a first passage of a first separator and a second passage of a second separator.

FIG. 6 is a plan view showing the positional relationship between the first passage of the first separator and the second passage of the second separator in a fuel cell stack in a modification.

FIGS. 7A to 7C are plan views showing an overlapping state of a first wave-shaped portion and a second wave-shaped portion in a modification.

FIG. 8 is a plan view showing the positional relationship between the first passage of the first separator and the second passage of the second separator in the fuel cell stack in a modification.

FIG. 9 is a plan view showing the positional relationship between the first passage of the first separator and the second passage of the second separator in the fuel cell stack in a modification.

FIGS. 10A to 10C are plan views when the amplitudes of the first wave-shaped portion and the second wave-shaped portion are changed in a modification.

FIGS. 11A to 11C are plan views when the wavelengths of the first wave-shaped portion and the second wave-shaped portion are changed in a modification.

FIG. 12 is a plan view of the first wave-shaped portion and the second wave-shaped portion in a modification.

FIGS. 13A to 13E are plan views of the first wave-shaped portion and the second wave-shaped portion in a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment will now be described with reference to the drawings.

### Fuel Cell 11

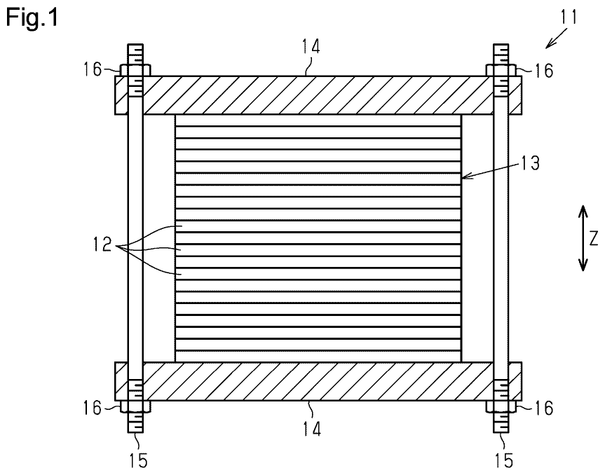

As shown in FIG. 1, the fuel cell 11 includes a fuel cell stack 13 and two end plates 14. The fuel cell stack 13 includes rectangular plate-shaped single cells 12 for generating power. The single cells 12 are stacked in the thickness direction Z. The two end plates 14 sandwich the fuel cell stack 13 at the opposite sides of the single cells 12 in the thickness direction Z (stacking direction).

The outer edges of the two end plates 14 are fastened to each other by bolts 15 and nuts 16, thereby pressing and compressing the fuel cell stack 13 in the thickness direction Z (stacking direction) of the single cells 12. A terminal plate (not shown) for collecting current and an insulating plate (not shown) for insulation are arranged between each of the two end plates 14 and the fuel cell stack 13.

### Single Cell 12

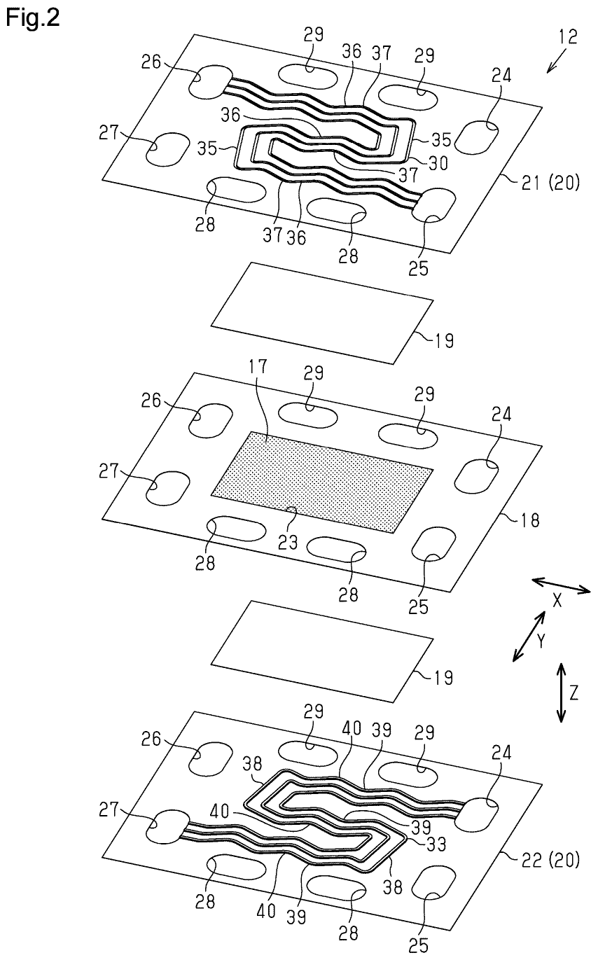

As shown in FIG. 2, the single cell 12 includes a rectangular sheet-shaped power generation portion 17, a rectangular plate-shaped support frame 18 that supports the power generation portion 17, two rectangular sheet-shaped gas diffusion layers 19 that sandwich the power generation portion 17, and two metal separators 20. The two separators 20 sandwich the support frame 18 that supports the power generation portion 17 sandwiched by the two gas diffusion layers 19.

One of the two separators 20 that is arranged at the cathode side is a first separator 21, and the other one of the two separators 20 that is arranged at the anode side is a second separator 22. The power generation portion 17 is supported while accommodated in a rectangular opening 23 formed in the central portion of the support frame 18. The power generation portion 17 is formed by a membrane electrode assembly (MEA).

In the following description, the long-side direction, the short-side direction, and the thickness direction of the single cell 12 are respectively referred to as a long-side direction X as an example of a first direction, a short-side direction Y as an example of a second direction, and a thickness direction Z. The long-side direction X, the short-side direction Y, and the thickness direction Z are orthogonal to each other.

### Passage Configuration in Single Cell 12

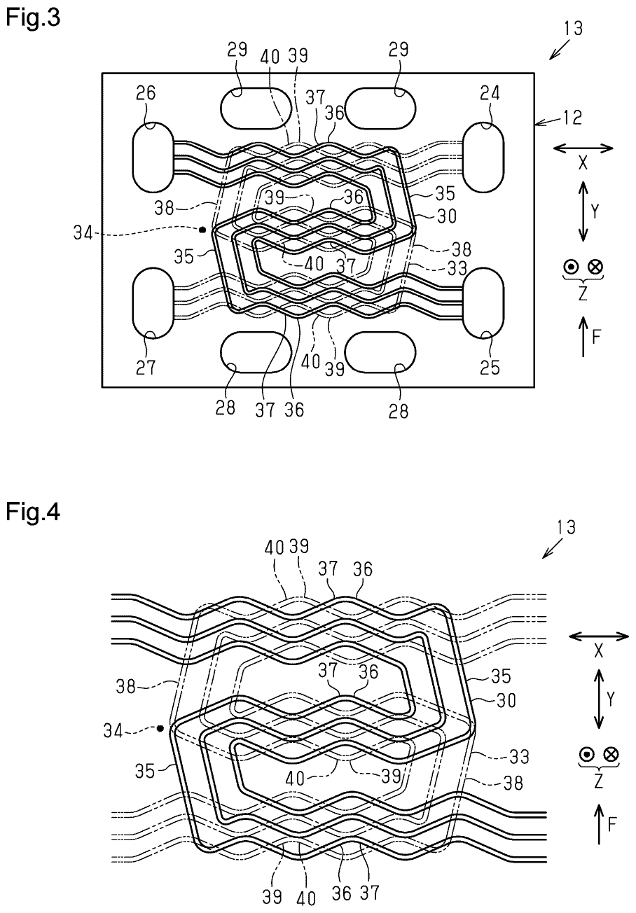

As shown in FIGS. 2 and 3, a fuel gas supply hole 24 and an oxidant gas discharge hole 25 are formed in a first end that is one of two ends located at the opposite sides of the power generation portion 17 of the single cell 12 in the long-side direction X. An oxidant gas supply hole 26 and a fuel gas discharge hole 27 are formed in a second end that is the other one of the two ends. The fuel gas supply hole 24 and the oxidant gas discharge hole 25 are elongated holes and are formed next to each other in the short-side direction Y.

The oxidant gas supply hole 26 and the fuel gas discharge hole 27 are elongated holes and are formed next to each other in the short-side direction Y. The fuel gas supply hole 24 is supplied with a fuel gas containing, for example, hydrogen. The fuel gas discharge hole 27 discharges the fuel gas. The oxidant gas supply hole 26 is supplied with an oxidant gas containing, for example, oxygen. The oxidant gas discharge hole 25 discharges the oxidant gas.

The fuel gas supply hole 24 and the oxidant gas supply hole 26 are opposed to each other in the long-side direction X. The oxidant gas discharge hole 25 and the fuel gas discharge hole 27 are opposed to each other in the long-side direction X.

Two cooling medium supply holes 28 are formed in a first end that is one of two ends located at the opposite sides of the power generation portion 17 of the single cell 12 in the short-side direction Y, and two cooling medium discharge holes 29 are formed in a second end that is the other one of the two ends. The two cooling medium supply holes 28 are elongated holes and are formed next to each other in the long-side direction X. The two cooling medium discharge holes 29 are elongated holes and are formed next to each other in the long-side direction X.

The two cooling medium supply holes 28 are supplied with a cooling medium, such as coolant. The two cooling medium discharge holes 29 discharge the cooling medium. The two cooling medium supply holes 28 and the two cooling medium discharge holes 29 are opposed to each other in the short-side direction Y.

The fuel gas supply hole 24, the fuel gas discharge hole 27, the oxidant gas supply hole 26, the oxidant gas discharge hole 25, the cooling medium supply holes 28, and the cooling medium discharge holes 29 of the single cell 12 each form a manifold extending through the fuel cell stack 13 in the thickness direction Z (stacking direction).

### Separator 20

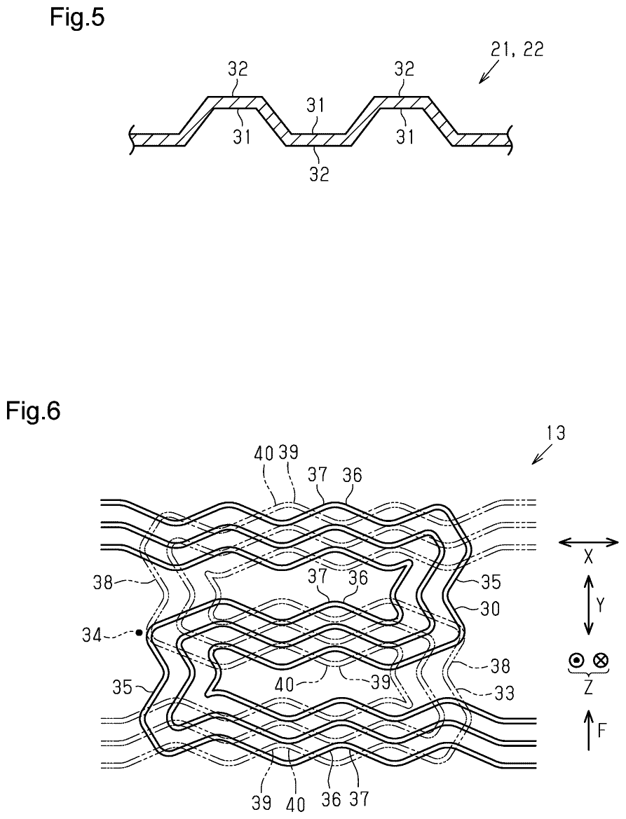

As shown in FIGS. 2, 3, and 5, first passages 30 connecting the oxidant gas supply hole 26 and the oxidant gas discharge hole 25 are arranged on the surface of the first separator 21 facing the power generation portion 17. The first passages 30, through which an oxidant gas flows, supply the oxidant gas to one of the surfaces of the power generation portion 17 from the oxidant gas supply hole 26 to the oxidant gas discharge hole 25. The first passages 30 are formed by recesses and projections in a complementary relationship that are formed on opposite surfaces by pressing the first separator 21. In the present embodiment, the recesses and projections forming each first passage 30 of the first separator 21 have trapezoidal shapes in a cross-sectional view.

The first passages 30 are formed by recess portions 31, which are parts of the recesses and projections of the first separator 21 and face the power generation portion 17. The recess portions 31 forming the first passages 30 extend in parallel at regular intervals. Projection portions 32 are formed between the recess portions 31 in the first separator 21. In the recesses and projections of the first separator 21, the recess portions 31 in one surface form the projection portions 32 in the other surface, and the projection portions 32 in the one surface form the recess portions 31 in the other surface.

The recesses and projections in the first separator 21 are arranged such that the recess portions 31 and the projection portions 32 are alternately arranged at equal intervals in the arrangement direction of the first passages 30. The first passages 30 in the first separator 21 extend in a meandering manner such that the flow direction of the oxidant gas is reversed multiple times (two times in present example). In other words, the first passages 30 are serpentine passages.

As shown in FIGS. 2, 3, and 5, second passages 33 connecting the fuel gas supply hole 24 and the fuel gas discharge hole 27 are arranged on the surface of the second separator 22 facing the power generation portion 17. The second passages 33, through which a fuel gas flows, supply the fuel gas to the other one of the surfaces of the power generation portion 17 that is opposite to the first separator 21 from the fuel gas supply hole 24 to the fuel gas discharge hole 27. The second passages 33 are formed by recesses and projections in a complementary relationship that are formed on opposite surfaces by pressing the second separator 22. In the present embodiment, the recesses and projections forming each second passage 33 of the second separator 22 have trapezoidal shapes in a cross-sectional view.

The second passage 33 are formed by the recess portions 31, which are parts of the recesses and projections of the second separator 22 and face the power generation portion 17. The recess portions 31 forming the second passages 33 extend in parallel at regular intervals. The projection portions 32 are formed between the recess portions 31 in the second separator 22. In the recesses and projections of the second separator 22, the recess portions 31 in one surface form the projection portions 32 in the other surface, and the projection portions 32 in the one surface form the recess portions 31 in the other surface.

The recesses and projections in the second separator 22 are arranged such that the recess portions 31 and the projection portions 32 are alternately arranged at equal intervals in the arrangement direction of the second passages 33. The second passages 33 in the second separator 22 extend in a meandering manner such that the flow direction of the fuel gas is reversed multiple times (two times in present example). In other words, the second passages 33 are serpentine passages.

As shown in FIGS. 2 to 4, the first separator 21 and the second separator 22 have the same configuration. In the single cell 12, the first separator 21 and the second separator 22 are arranged such that one of the separators is reversed with respect to the other one. In this case, when the first separator 21 and the second separator 22 are viewed in the thickness direction Z, the fuel gas supply holes 24, the fuel gas discharge holes 27, the oxidant gas supply holes 26, the oxidant gas discharge holes 25, the two cooling medium supply holes 28, and the two cooling medium discharge holes 29 overlap each other.

### Fuel Cell Stack 13

As shown in FIGS. 1 to 4, a cooling medium flow region 34 through which a cooling medium flows from the cooling medium supply holes 28 toward the cooling medium discharge holes 29 is formed between the first separator 21 of one of two single cells 12, adjacent to each other in the thickness direction Z (stacking direction) in the fuel cell stack 13, and the second separator 22 of the other one of the two single cells 12. Thus, a flow direction F of the cooling medium in the cooling medium flow region 34 is a direction extending from the cooling medium supply holes 28 toward the cooling medium discharge holes 29 and extending parallel to the short-side direction Y.

The cooling medium flow region 34 is in contact with the recesses and projections forming the first passages 30 of the first separator 21 and the recesses and projections forming the second passages 33 of the second separator 22. Thus, the recesses and projections forming the first passages 30 of the first separator 21 and the recesses and projections forming the second passages 33 of the second separator 22 affect the cooling medium flowing in the cooling medium flow region 34.

In each of the first passages 30 of the first separator 21, portions for reversing the flow of an oxidant gas are referred to as first reversal portions 35, and portions different from the first reversal portions 35 are referred to as first general portions 36.

The first reversal portions 35 have a straight shape and extend diagonally with respect to the flow direction F of a cooling medium to increase the flow resistance of the cooling medium flowing through a part of the cooling medium flow region 34 that corresponds to the first reversal portions 35. The first general portions 36 extend in the long-side direction X. The first general portions 36 are first wave-shaped portions 37 as an example of a wave-shaped portion extending in a wave-shaped manner as a whole.

In each of the second passages 33 of the second separator 22, portions for reversing the flow of a fuel gas are referred to as second reversal portions 38, and portions different from the second reversal portions 38 are referred to as second general portions 39.

The second reversal portions 38 have a straight shape and extend diagonally with respect to the flow direction F of the cooling medium to increase the flow resistance of the cooling medium flowing through a part of the cooling medium flow region 34 that corresponds to the second reversal portions 38. The second general portions 39 extend in the long-side direction X. The second general portions 39 are second wave-shaped portions 40 as an example of a wave-shaped portion extending in a wave-shaped manner as a whole.

When the first separator 21 and the second separator 22 are stacked in the thickness direction Z (stacking direction), the phase of the first wave-shaped portion 37 of the first general portion 36 of each first passage 30 and the phase of the second wave-shaped portion 40 of the second general portion 39 of each second passage 33 are shifted from each other.

In the first separator 21 and the second separator 22 when viewed from the thickness direction Z, the first passages 30 of the first separator 21 and the second passages 33 of the second separator 22 extend to intersect with each other. In this case, the first passages 30 of the first separator 21 and the second passages 33 of the second separator 22 do not overlap at all in a parallel arrangement with each other in the thickness direction Z.

### Operation of Embodiment

As shown in FIGS. 1 to 4, when the fuel cell 11 is supplied with an oxidant gas, a fuel gas, and a cooling medium, the single cells 12 of the fuel cell stack 13 each generate power. When the single cells 12 generate power, the oxidant gas is supplied from the oxidant gas supply hole 26, and the fuel gas is supplied from the fuel gas supply hole 24.

When the oxidant gas is supplied from the oxidant gas supply hole 26 in the single cell 12, the oxidant gas is supplied to the cathode-side surface of the power generation portion 17 while being diffused by the gas diffusion layer 19 in a process of flowing through each first passage 30 toward the oxidant gas discharge hole 25. The oxidant gas flowing into the oxidant gas discharge hole 25 is discharged out of the fuel cell stack 13.

When the fuel gas is supplied from the fuel gas supply hole 24 in the single cell 12, the fuel gas is supplied to the anode-side surface of the power generation portion 17 while being diffused by the gas diffusion layer 19 in a process of flowing through each second passage 33 toward the fuel gas discharge hole 27. The fuel gas flowing into the fuel gas discharge hole 27 is discharged out of the fuel cell stack 13.

In this case, the single cells 12 each generate power based on an electrochemical reaction in the power generation portion 17 between the oxidant gas supplied to the cathode-side surface of the power generation portion 17 and the fuel gas supplied to the anode-side surface of the power generation portion 17.

The single cells 12 each generate heat resulting from power generation through the electrochemical reaction. In view of this, the cooling medium flows from the cooling medium supply holes 28 toward the cooling medium discharge holes 29 in the cooling medium flow region 34 formed between the first separator 21 of one of two single cells 12, adjacent to each other in the fuel cell stack 13, and the second separator 22 of the other one of the two single cells 12. This cools the single cells 12. The cooling medium flowing into the cooling medium discharge hole 29 is discharged out of the fuel cell stack 13.

In this case, in general, the recesses and projections forming the first passages 30 of the first separator 21 and the second passages 33 of the second separator 22 are in a complementary relationship. Thus, the recesses and projections serve as a flow resistance when the cooling medium flows through the cooling medium flow region 34. Since the first passages 30 and the second passages 33 are meandering passages, the first general portions 36 and the second general portions 39 normally extend to be orthogonal to the flow direction F of the cooling medium, and the first reversal portions 35 and the second reversal portions 38 extend in the flow direction F of the cooling medium.

Thus, the flow resistance when the cooling medium flows through the cooling medium flow region 34 is greater in parts of the cooling medium flow region 34 that correspond to the first general portions 36 and the second general portions 39 than in parts of the cooling medium flow region 34 that correspond to the first reversal portions 35 and the second reversal portions 38. Thus, the cooling medium flow region 34 has parts where the cooling medium flows easily and parts where the cooling medium flows less easily. This results in variation in the cooling effect of the cooling medium in the single cell 12.

In this respect, in the present embodiment, the first reversal portions 35 of the first passages 30 extend diagonally with respect to the flow direction F of the cooling medium to increase the flow resistance of the cooling medium flowing through the part of the cooling medium flow region 34 that corresponds to the first reversal portions 35. In addition, the second reversal portions 38 of the second passages 33 extend diagonally with respect to the flow direction F of the cooling medium to increase the flow resistance of the cooling medium flowing through the part of the cooling medium flow region 34 that corresponds to the second reversal portions 38.

Thus, the difference in the flow resistance, when the cooling medium flows, is reduced between the parts of the cooling medium flow region 34 that correspond to the first reversal portions 35 and the second reversal portions 38 and the parts of the cooling medium flow region 34 that correspond to the first general portions 36 and the second general portions 39. The cooling medium flows through the cooling medium flow region 34 in a balanced manner, thereby reducing variation in the cooling effect of the cooling medium in the single cells 12.

### Advantages of Embodiment

The above-described embodiment has the following advantages.

(1) In the fuel cell stack 13, the first reversal portions 35 of the first passages 30 extend diagonally with respect to the flow direction F of the cooling medium to increase the flow resistance of the cooling medium flowing through the part of the cooling medium flow region 34 that corresponds to the first reversal portions 35. In addition, the second reversal portions 38 of the second passages 33 extend diagonally with respect to the flow direction F of the cooling medium to increase the flow resistance of the cooling medium flowing through the part of the cooling medium flow region 34 that corresponds to the second reversal portions 38.

With the above configuration, the difference in the flow resistance, when the cooling medium flows, is reduced between the parts of the cooling medium flow region 34 that correspond to the first reversal portions 35 and the second reversal portions 38 and the parts of the cooling medium flow region 34 that correspond to the first general portions 36 and the second general portions 39. The cooling medium flows through the cooling medium flow region 34 in a balanced manner, thereby reducing variation in the cooling effect of the cooling medium in the single cells 12.

(2) In the fuel cell stack 13, the first general portions 36 of the first passages 30 and the second general portions 39 of the second passages 33 are respectively the first wave-shaped portions 37 and the second wave-shaped portions 40 as a whole. The phase of the first wave-shaped portions 37 of the first passages 30 and the phase of the second wave-shaped portions 40 of the second passages 33 are shifted from each other when the first separator 21 and the second separator 22 are stacked.

With the above configuration, the phase of the first wave-shaped portions 37 of the first passages 30 and the phase of the second wave-shaped portions 40 of the second passages 33 are shifted to change the flow resistance of the cooling medium flowing through parts of the cooling medium flow region 34 that correspond to the first general portions 36 of the first passages 30 and the second general portions 39 of the second passages 33 compared to when the phases are not shifted.

(3) In the fuel cell stack 13, the first separator 21 and the second separator 22 have the same configuration.

With the above configuration, the first separator 21 and the second separator 22 can be the same components, and the quantity of components will be reduced compared to when the first separator 21 and the second separator 22 are different components.

(4) In the first separator 21 and the second separator 22 of the fuel cell stack 13 when viewed from the thickness direction Z, the first passages 30 of the first separator 21 and the second passages 33 of the second separator 22 extend to intersect with each other. In this case, the first passages 30 of the first separator 21 and the second passages 33 of the second separator 22 do not overlap at all in a parallel arrangement with each other in the thickness direction Z.

With the above configuration, when the single cells 12 are stacked to form the fuel cell stack 13, the first passages 30 of the first separator 21 and the second passages 33 of the second separator 22 directly overlap and intersect with each other. This arrangement avoids fitting of the recesses and projections to each other, even if there is a slight displacement in their overlapping positions. This applies to the first separator 21, where the first passages 30 are formed by the recesses and projections in a complementary relationship, and the second separator 22, where the second passages 33 are formed by the recesses and projections in a complementary relationship. Thus, although the first separator 21 and the second separator 22 have the same configuration, a planar pressure between the single cells 12 is ensured when the fuel cell stack 13 is formed by stacking the single cells 12. This will maintain the power generation performance of the fuel cell 11.

The single cells 12 have a reduced stacking thickness at a fitted portion when the recesses and projections in a complementary relationship, forming the first passages 30 of the first separator 21, are fitted to the recesses and projections in a complementary relationship, forming the second passages 33 of the second separator 22. Thus, the planar pressure between the single cells 12 is not ensured when single cells 12 are stacked to form the fuel cell stack 13. This will degrade the power generation performance of the fuel cell 11.

### Modifications

The above-described embodiment may be modified as follows. The above-described embodiment and the following modifications can be combined as long as the combined modifications remain technically consistent with each other.

As shown in FIG. 6, the first reversal portions 35 of the first passages 30 and the second reversal portions 38 of the second passages 33 may extend in a wave-shaped manner. This will further increase the flow resistance of a cooling medium flowing through parts of the cooling medium flow region 34 that correspond to the first reversal portions 35 and the second reversal portions 38. Thus, the difference in the flow resistance, when the cooling medium flows, is further reduced between the parts of the cooling medium flow region 34 that correspond to the first reversal portions 35 and the second reversal portions 38 and the parts of the cooling medium flow region 34 that correspond to the first general portions 36 and the second general portions 39.

In the case of FIG. 6, the first reversal portions 35 of the first passages 30 and the second reversal portions 38 of the second passages 33 may extend in parallel to the flow direction F of the cooling medium in the cooling medium flow region 34. This will further increase the flow resistance of the cooling medium flowing through the parts of the cooling medium flow region 34 that correspond to the first reversal portions 35 and the second reversal portions 38 compared to when the first reversal portions 35 of the first passages 30 and the second reversal portions 38 of the second passages 33 have a straight shape.

In the case of FIG. 6, the amplitudes of the wave-shaped first reversal portions 35 and the wave-shaped second reversal portions 38 may be greater or less than the amplitudes of the first wave-shaped portions 37 and the second wave-shaped portions 40.

In the case of FIG. 6, the wavelengths of the wave-shaped first reversal portions 35 and the wave-shaped second reversal portions 38 may be greater or less than the wavelengths of the first wave-shaped portions 37 and the second wave-shaped portions 40.

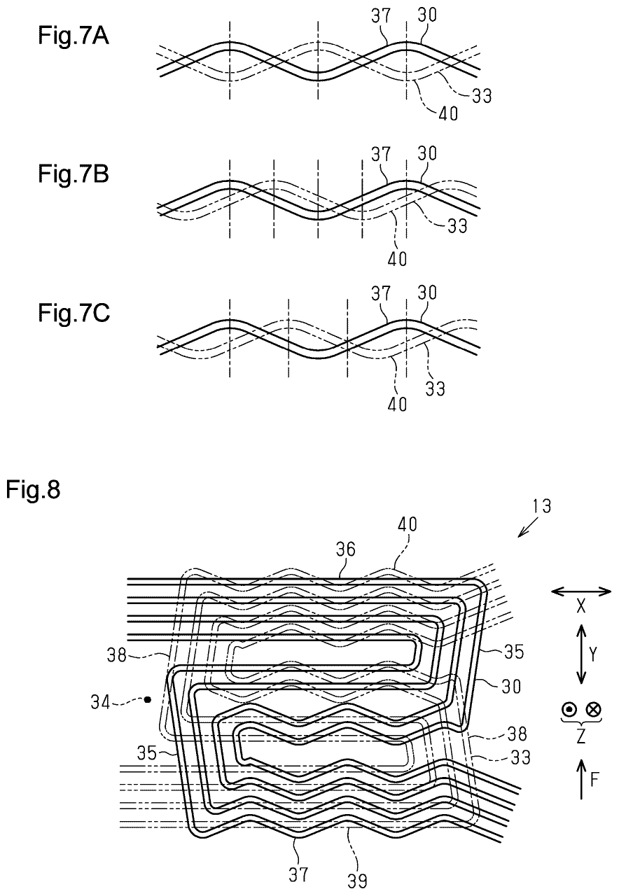

As shown in FIG. 7A, the phase of the first wave-shaped portion 37 of the first passage 30 and the phase of the second wave-shaped portion 40 of the second passage 33 may be shifted by a half pitch.

As shown in FIG. 7B, the phase of the first wave-shaped portion 37 of the first passage 30 and the phase of the second wave-shaped portion 40 of the second passage 33 may be shifted by a quarter pitch.

As shown in FIG. 7C, the phase of the first wave-shaped portion 37 of the first passage 30 and the phase of the second wave-shaped portion 40 of the second passage 33 may be shifted by one-third of a pitch.

As shown in FIG. 8, a half (part) of the first general portions 36 of the first passages 30 and a half (part) of the second general portions 39 of the second passages 33 may have a straight shape.

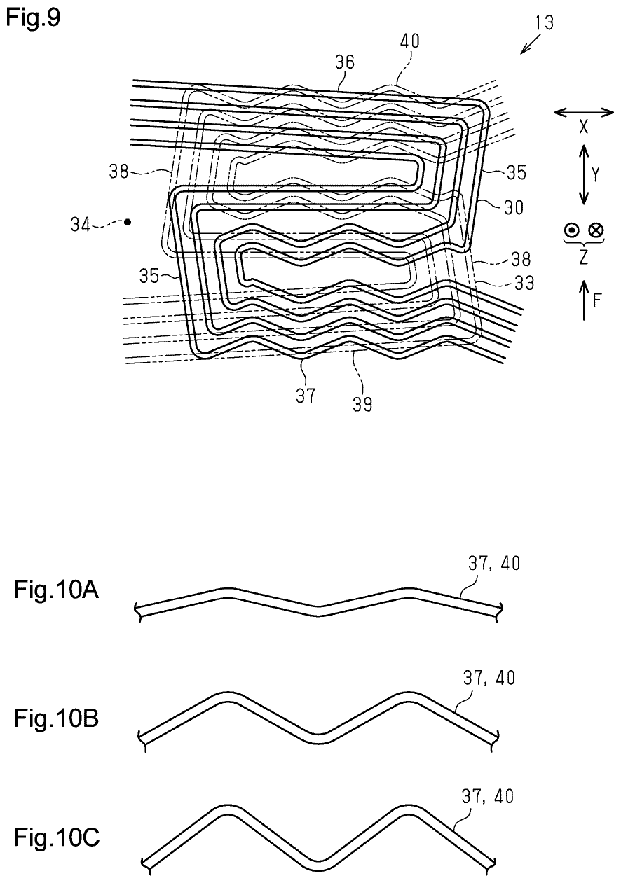

As shown in FIG. 9, the straight portions of the first general portions 36 of the first passages 30 and the straight portions of the second general portions 39 of the second passages 33 of FIG. 8 may extend diagonally with respect to the long-side direction X.

As shown in FIGS. 10A, 10B, and 10C, the amplitudes of the first wave-shaped portion 37 and the second wave-shaped portion 40 may be changed. In FIGS. 10A, 10B, and 10C, the amplitudes of the first wave-shaped portion 37 and the second wave-shaped portion 40 are smallest in FIG. 10A and largest in FIG. 10C.

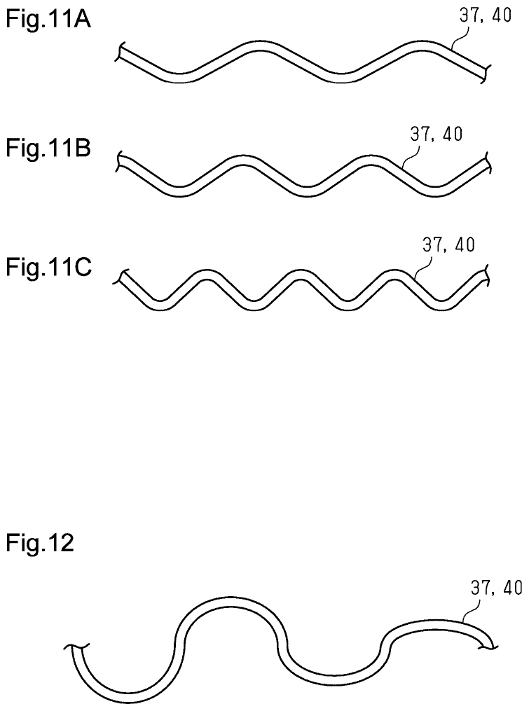

As shown in FIGS. 11A, 11B, and 11C, the wavelengths of the first wave-shaped portion 37 and the second wave-shaped portion 40 may be changed. In FIGS. 11A, 11B, and 11C, the wavelengths of the first wave-shaped portion 37 and the second wave-shaped portion 40 are longest in FIG. 11A and shortest in FIG. 11C.

As shown in FIG. 12, the amplitudes of the first wave-shaped portion 37 and the second wave-shaped portion 40 may be gradually decreased or increased.

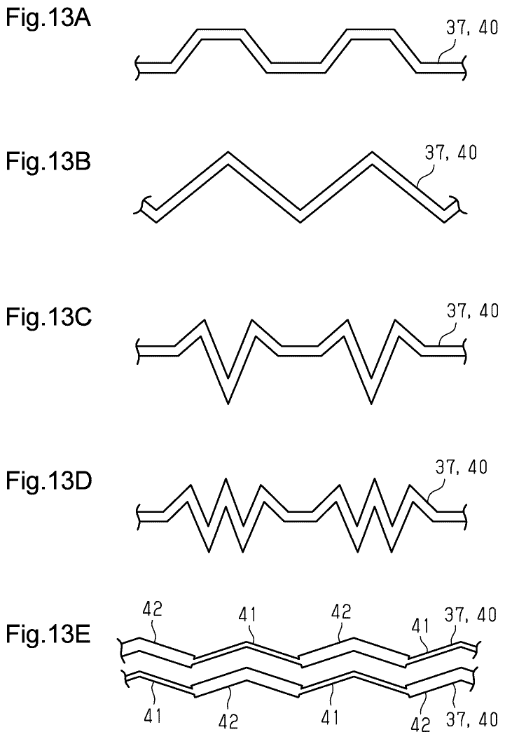

As shown in FIG. 13A, the first wave-shaped portion 37 and the second wave-shaped portion 40 may have a trapezoidal shape.

As shown in FIG. 13B, the first wave-shaped portion 37 and the second wave-shaped portion 40 may have a zigzag shape.

As shown in FIG. 13C, the first wave-shaped portion 37 and the second wave-shaped portion 40 may be V-shaped.

As shown in FIG. 13D, the first wave-shaped portion 37 and the second wave-shaped portion 40 may be W-shaped.

As shown in FIG. 13E, the first wave-shaped portions 37 and the second wave-shaped portions 40 may have a zigzag shape such that narrow portions 41, which are narrow, and wide portions 42, which are wider than the narrow portions 41, are alternately arranged. This allows an oxidant gas and a fuel gas to easily enter the gas diffusion layers 19 from the first wave-shaped portions 37 and the second wave-shaped portions 40.

The shapes of FIGS. 13A to 13E may be applied to the first reversal portions 35 and the second reversal portions 38 in FIG. 6.

The first separator 21 and the second separator 22 may have configurations differing from each other.

The first general portions 36 of the first passages 30 and the second general portions 39 of the second passages 33 may partially be the first wave-shaped portions 37 and the second wave-shaped portions 40, respectively. The phase of the first wave-shaped portions 37 of the first passages 30 and the phase of the second wave-shaped portions 40 of the second passages 33 do not need to be shifted from each other when the first separator 21 and the second separator 22 are stacked.

Either the first general portions 36 of the first passages 30 or the second general portions 39 of the second passages 33 may have a straight shape.

The position of the oxidant gas discharge hole 25 and the position of the oxidant gas supply hole 26 may be swapped.

The position of the fuel gas supply hole 24 and the position of the fuel gas discharge hole 27 may be swapped.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising:
stacked single cells, the single cells each having a plate shape and including a power generation portion and a pair of a first separator and a second separator that sandwiches the power generation portion, wherein
the single cells each include:
a fuel gas supply hole through which a fuel gas is supplied;
a fuel gas discharge hole through which the fuel gas is discharged;
an oxidant gas supply hole through which an oxidant gas is supplied; and
an oxidant gas discharge hole through which the oxidant gas is discharged,
the fuel gas supply hole is formed at a first end that is one of two ends of the single cell in a first direction,
the fuel gas discharge hole is formed at a second end that is an other one of the two ends of the single cell in the first direction,
the oxidant gas supply hole is formed at one of the first end and the second end of the single cell in the first direction,
the oxidant gas discharge hole is formed at an other one of the first end and the second end of the single cell in the first direction,
the single cells each further include:
a cooling medium supply hole through which a cooling medium is supplied; and
a cooling medium discharge hole through which the cooling medium is discharged,
the cooling medium supply hole is formed at a first end that is one of two ends of the single cell in a second direction orthogonal to the first direction,
the cooling medium discharge hole is formed at a second end that is an other one of the two ends of the single cell in the second direction,
the first separator includes recesses and projections in a complementary relationship, the recesses and projections forming first passages for supplying the oxidant gas to one of surfaces of the power generation portion from the oxidant gas supply hole to the oxidant gas discharge hole, the first passages serving as meandering passages in which a flow direction of the oxidant gas is reversed multiple times,
the first passages each include first reversal portions for reversing a flow of the oxidant gas and first general portions different from the first reversal portions,
the second separator includes recesses and projections in a complementary relationship, the recesses and projections forming second passages for supplying the fuel gas to an other one of the surfaces of the power generation portion from the fuel gas supply hole to the fuel gas discharge hole, the second passages serving as meandering passages in which a flow direction of the fuel gas is reversed multiple times,
the second passages each include second reversal portions for reversing a flow of the fuel gas and second general portions different from the second reversal portions,
a cooling medium flow region through which the cooling medium flows from the cooling medium supply hole toward the cooling medium discharge hole is formed between the first separator of one of two single cells, adjacent to each other in a stacking direction, and the second separator of an other one of the two single cells,
at least part of at least either the first general portions of the first passages or the second general portions of the second passages is a wave-shaped portion extending in a wave-shaped manner,
the first reversal portions of the first passages each extend to increase a flow resistance of the cooling medium flowing through a part of the cooling medium flow region that corresponds to the first reversal portion, and
the second reversal portions of the second passages each extend to increase the flow resistance of the cooling medium flowing through a part of the cooling medium flow region that corresponds to the second reversal portion.

2. The fuel cell stack according to claim 1, wherein the first reversal portions and the second reversal portions extend diagonally with respect to a flow direction of the cooling medium in the cooling medium flow region.

3. The fuel cell stack according to claim 1, wherein the first reversal portions and the second reversal portions extend in a wave-shaped manner.

4. The fuel cell stack according to claim 1, wherein
the first general portions of the first passages and the second general portions of the second passages are the wave-shaped portion as a whole, and
a phase of the wave-shaped portion of the first passages and a phase of the wave-shaped portion of the second passages are shifted from each other when the first separator and the second separator are stacked.

5. The fuel cell stack according to claim 1, wherein the first separator and the second separator have a same configuration.
